(19) United States
(12) Patent Application Publication
(10) Pub. No.: US 2023/0267475 A1
(43) Pub. Date: Aug. 24, 2023

(54) SYSTEMS AND METHODS FOR AUTOMATED CONTEXT-AWARE SOLUTIONS USING A MACHINE LEARNING MODEL

(71) Applicant: THE TORONTO-DOMINION BANK, Toronto (CA)

(72) Inventors: MIGUEL NAVARRO, EWING, NJ (US); ROMAN MELNYK, WINDHAM, ME (US)

(21) Appl. No.: 17/679,891

(22) Filed: Feb. 24, 2022

(51) Int. Cl. G06Q 30/00; G06F 16/951; G06F 16/954; G06N 20/00

(52) U.S. Cl. CPC G06Q 30/016; G06F 16/951; G06F 16/954; G06N 20/00

(57) ABSTRACT

A predictive context aware system, method and device tracks customer attributes comprising: an online customer behaviour of a particular customer of an entity when interacting with a computer application including a particular flow of navigational events when browsing the application indicative of the particular customer seeking assistance; provides the tracked customer attributes to a predictive machine learning model to determine a prediction of a primary intent comprising: at least one predicted problem encountered by the customer associated with the tracked customer attributes and a context of actions derived from the customer attributes, the model trained based on prior historical behaviour of other customers in the entity comprising browser navigational flows for others indicative of a known associated problem; dynamically determines a solution to the predicted problem based on accessing a database linking similar problems; and presents the solution and associated context of the solution to the computer device.

### FIELD

The present disclosure relates to systems and methods for automated online customer intent or issue prediction, and more particularly predicting a customer's expected online intent using a machine learning model and for providing a possible online solution for the predicted issue.

### BACKGROUND

Customers requiring support want answers to their questions as soon as possible and with the least amount of effort. However, contacting customer support for assistance is often a time consuming process, potentially requiring the customer to wait in a queue before connecting to an appropriate customer service representative, explaining the context of the issue(s) including what attempts or efforts have been made to resolve the issue, and waiting for the customer service representative to search and provide the appropriate answers to resolve the issue(s).

The process of receiving customer support and answers to specific customer questions can be time consuming. Customers must search through commonly answered questions to find one that that specifically addresses their issue or contextualize their experience to a customer service representative which is then followed by the customer service representative providing a solution to the customer's experience-based issue explanation.

Existing methods thus lead to ineffective and manual ways of communicating issues and resolving same which leads to inaccuracies, wastes unnecessary computing resources, requires manual intervention and/or is unable to provide a full analysis of the transactions performed.

Thus, there is a need to automatically contextualize a customer's experience online in order to predict the customer's issue(s), intent for seeking support, and to proactively allow for a targeted response to be provided thereof.

### SUMMARY

In at least some aspects, it is desirable to have a context-aware machine learning computer system and method that monitors and analyzes individual customer's online behavior and activities in order to contextualize what a customer may be experiencing, predicts the primary intent for why the customer may be in need of support and provides customized outputs which address the predicted primary intent and context experienced by the customer.

In at least some aspects, the ability to automatically predict a customer's issue(s) while browsing online, predicting solution(s) to the customer's predicted issue(s) and then providing targeted solution(s) on the associated computing devices associated with the navigational issues faced based on the customer's predicted issue(s) would help overcome the time consuming process associated with resolving an issue and help improve the customer's overall digital experience, particularly when navigating an online environment.

According to an aspect of the present disclosure, there is provided a computer system and method that monitors and analyses individual customer's data relating to their online behavior and activities (e.g. location, timing, device, etc.) in order to automatically profile and contextualize their experience (e.g. failed log in) and predict their intent for seeking support (e.g. how to reset a password).

At least in some aspects, such systems and methods use a machine learning model, having been trained on an input training dataset of customer behavior and activities associated with various issues and experiences, uses derived formulas and algorithms to predict issue(s) a customer may be experiencing based on a summation of data associated with that particular customer. Such systems and methods may consider both the history and sequence of certain events in predicting a particular customer's issue(s) and intent for seeking or requiring support.

A system of one or more computers can be configured to perform particular operations or actions by virtue of having software, firmware, hardware, or a combination of the aforementioned components installed on the system that in operation cause or causes the system to perform the actions. One or more computer programs can be configured to perform particular operations or actions by virtue of including instructions that, when executed by data processing apparatus, cause the apparatus to perform the actions. One general aspect includes a computer system for automatically predicting a customer's issue(s) and intent for seeking or requiring support, when interacting with one or more data transmission deceives in communication with the computer system and comprises: a computer processor; and a non-transitory computer-readable storage medium having instructions that when executed by the computer processor perform actions which may include: receiving at a machine learning model, a first input of a training dataset of customer behavior and activities, the training dataset including customer issues and associated customer experiences, the machine learning model having been trained using the training dataset and the training dataset including a set of features defining the training dataset; receiving, at the machine learning model, a second input of active customer data, defined using a same set of features as the first input; in response to applying the inputs to the machine learning model, the machine learning model is configured to: analyse the active customer data to assess a particular customer's behaviours and activities; predict based, on the customer's behaviours and activities, issue(s) the customer may be experiencing; predict based, on the customer's behaviours and activities, the customer's intent for seeking support; provided customized outputs to address the predicted issue(s) the customer may be experiencing; and provided customized outputs to address the predicted customer's intent for seeking support. Other embodiments of this aspect include corresponding computer systems, apparatus, and computer programs recorded on the one or more computer storage devices, each configured to perform the actions of the methods.

Implementations may include one or more of the following features. The system and method where the machine-learning model receives inputs from customers synchronized across different computing platforms (i.e., mobile device, online, chat bot, etc.) allowing for a seamless transaction for customers who may be accessing the services on more than one platform.

In accordance with one aspect, there is provided a computer implemented method for dynamically providing predictive context-aware solutions on computing devices to online customers, the method comprising: tracking customer attributes comprising: an online customer behaviour of a particular customer of an entity when interacting with a computer application associated with the entity and on a computer device, the online customer behaviour tracked comprising: a particular flow of navigational events when browsing the application indicative of the particular customer seeking assistance; providing the tracked customer attributes to a predictive machine learning model to determine a prediction of a primary intent comprising: at least one predicted problem encountered by the customer associated with the tracked customer attributes and a context of actions derived from the customer attributes, the model being trained based on prior historical behaviour of other customers in the entity comprising browser navigational flows for others indicative of a known associated problem; dynamically determining a solution to the predicted problem based on accessing a database linking similar problems and associated solutions; and presenting the solution and associated context of the solution to a user interface of the computer device associated with the computer application for the customer.

One general aspect includes a non-transitory computer-readable storage medium may include instructions executable by a processor for automatically predicting a customer's issue(s) and intent for seeking or requiring support, when interacting with one or more data transmission deceives in communication with the non-transitory computer-readable storage medium. The non-transitory computer-readable storage medium also include, receives at a machine learning model, a first input of a training dataset of customer behavior and activities, the training dataset including customer issues and associated customer experiences, the machine learning model having been trained using the training dataset and the training dataset including a set of features defining the training dataset; receive, at the machine learning model, a second input of active customer data, defined using a same set of features as the first input; in response to applying the inputs to the machine learning model, the machine learning model is configured to: analyse the active customer data to assess a particular customer's behaviours and activities; predict based, on the customer's behaviours and activities, issue(s) the customer may be experiencing; predict based, on the customer's behaviours and activities, the customer's intent for seeking support; provided customized outputs to address the predicted issue(s) the customer may be experiencing; and provided customized outputs to address the predicted customer's intent for seeking support. Other embodiments of this aspect include corresponding computer systems, apparatus, and computer programs recorded on the one or more computer storage devices, each configured to perform the actions of the methods.

One general aspect includes a computer implemented method of automatically predicting a customer's issue(s) and intent for seeking or requiring support, when interacting with one or more data transmission deceives in communication with a computer system. The computer implemented method also includes, receiving at a machine learning model, a first input of a training dataset of customer behavior and activities, the training dataset including customer issues and associated customer experiences, the machine learning model having been trained using the training dataset and the training dataset including a set of features defining the training dataset; receiving, at the machine learning model, a second input of active customer data, defined using a same set of features as the first input; in response to applying the inputs to the machine learning model, the machine learning model is configured to: analyse the active customer data to assess a particular customer's behaviours and activities; predict based, on the customer's behaviours and activities, issue(s) the customer may be experiencing; predict based, on the customer's behaviours and activities, the customer's intent for seeking support; provided customized outputs to address the predicted issue(s) the customer may be experiencing; and provided customized outputs to address the predicted customer's intent for seeking support. Other embodiments of this aspect include corresponding computer systems, apparatus, and computer programs recorded on the one or more computer storage devices, each configured to perform the actions of the methods.

### BRIEF DESCRIPTION OF THE DRAWINGS

These and other features of the disclosure will become more apparent from the following description in which reference is made to the appended drawings wherein:

FIG. 1 shows an example prediction engine, according to one embodiment;

FIG. 2 is a diagram illustrating an example computing device including the prediction engine of FIG. 1 according to one embodiment;

FIG. 3 is a diagram illustrating an example prediction engine; according to a further embodiment;

FIG. 4 is a flowchart illustrating example operations of a computing device, such as the computing device of FIG. 2, according to one embodiment;

FIGS. 5A-5C are example screens of a user interface of an example computing device, such as a customer device interacting with an entity application or website, and for presenting possible actions in response to example predictions, according to one embodiment; and

FIG. 6 illustrates an example flow chart of operations of a computing device, such as the computing device of FIG. 2, according to one embodiment.

### DETAILED DESCRIPTION

Generally, in at least some embodiments there is provided systems and methods that capture online customer behaviours and activities (e.g. for customers of an entity) to predict issue(s) a customer may be experiencing while navigating online. In at least some aspects, the predicted issue(s) in combination with captured customer behaviours and activities may be used to further predict likely computer implemented solutions, including computing resources for the predicted issue(s). In further embodiments, the predicted issue(s) and predicted solution(s) may be used to output recommend actions for the system to implement, such as displaying specific content to the customer, directing the customer to electronic resources, displaying specific information to a customer service agent and if applicable, connecting respective computing devices of the customer service agent and the customer (e.g. computing device 200) for subsequent solution resolution, or providing responses for the customer service agent to provide to the customer while interacting online. In at least some aspects, a further module may provide targeted content or information to the customer, such as for the purposes of marketing or advertising products based on identified customer behaviours and activities.

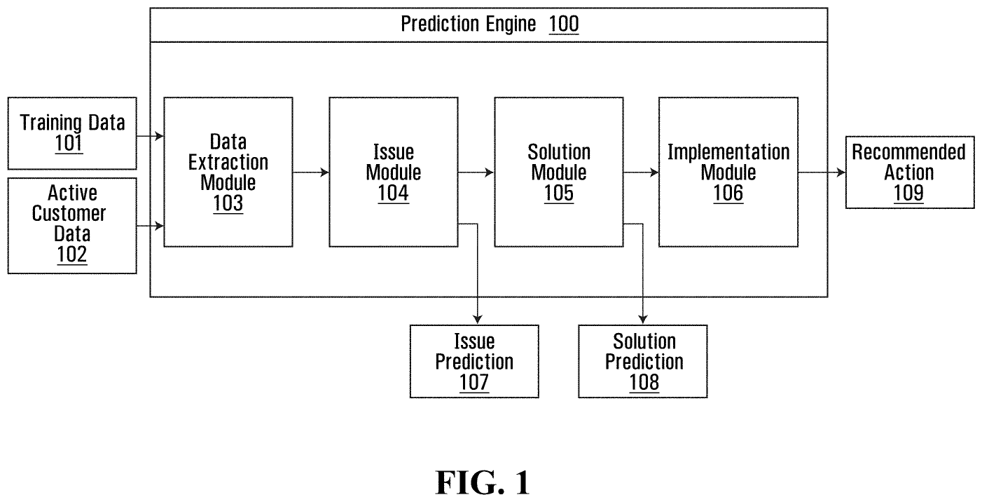

Referring to FIG. 1 shown is an example prediction engine 100, according to one embodiment. The prediction engine 100 comprises: a data extraction module 103, an issue module 104, a solutions module 105, and an implementation module 106. In one embodiment, the prediction engine 100 is configured for using one or more training datasets (e.g. training data 101 and/or active customer data 102) to build prediction modules (e.g. issue module 104, solution module 105) and implementation modules (e.g. implementation module 106) utilizing supervised machine-learning to predict a customer's issue(s) while interacting online, predict solutions to predicted issue(s), and determine recommended actions to be implemented, in real time based on assessing data on the particular customer's activities and behaviours (e.g. active customer data 102).

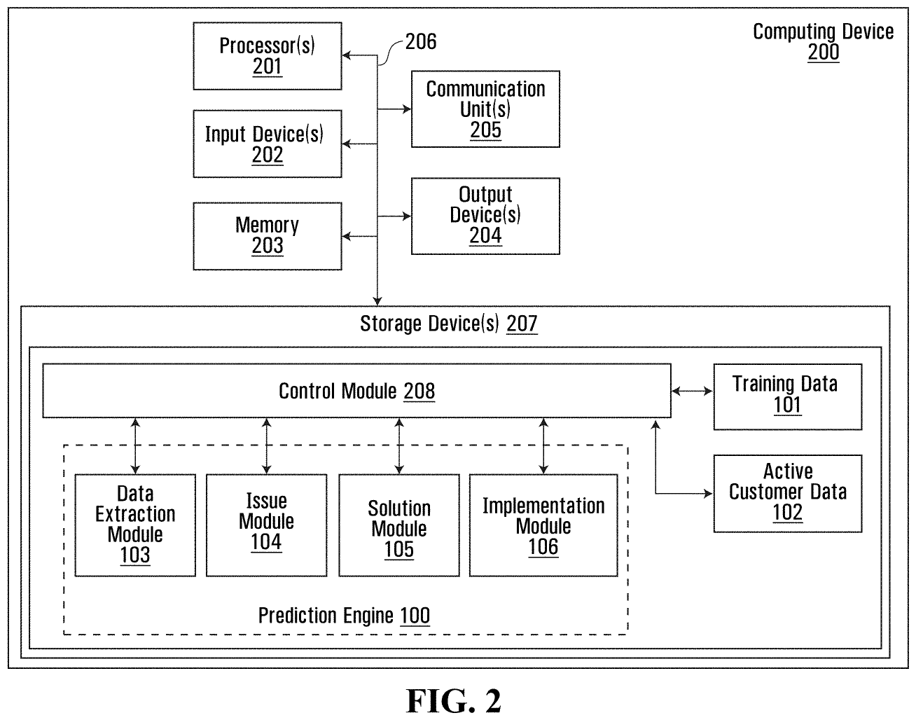

The prediction engine 100 further comprises data stores or repository for storing training data 101 and active customer data 102. In some aspects, the generated issue prediction 107, solution prediction 108, and recommended action(s) 109 may be stored in corresponding data stores or repositories of the prediction engine 100. The training data 101 and active customer data 102 may be received from another computing device across a communication network (e.g. a customer device of a computing device of an entity in a networked computer system for the entity) or at least partially input by a customer at a computing device for the prediction engine 100 (e.g. a computing device 200 shown at FIG. 2).

The prediction engine 100 may include additional computing modules or data stores in various embodiments. The prediction engine 100 is configured for receiving customer data including training data 101 (e.g. previous customer activities and behaviours and the associated issue(s) experienced by the customer, associated solutions implemented, and the result of such solution implementations) and active customer data 102 (e.g. current activities and online behaviours performed by a particular customer such as transaction information and browser/computer application navigation information); extracting relevant features of the data via the data extraction module 103; predicting issue(s) experienced by the customer while navigating online via an associated computing device using a machine-learning based issue module 104, predicting solution(s) to predicted issued experienced by the customer while navigating online via a machine-learning based solution module 105, determining optimal actions to be output to a computing device associated with the customer via a machine-learning based implementation module 106. Issue module 104 generates an issue prediction 107 (e.g. the customer is likely unable to remember their password when they are browsing online) for likely issue(s) experienced by a particular customer while interacting in an online environment (e.g. such as a website or a computing device associated with the prediction engine 100), having been trained on training data 101, based on active customer data 102. Solution module 105 generates a solution prediction 108 (e.g. the customer likely needs to reset their password via a digital link or website to do same, the customer likely needs a digital prompt to be reminded of their password) for likely solutions to resolve the issue prediction 107. Implementation module 106 determines a recommended action 109 (e.g. update a ‘FAQ’ page to show digital content related to how to reset a password; present a password prompt to the customer on a website associated with the prediction engine 100 to aid the customer in remembering their password; send the customer a password reset link via the prediction engine 100 to be displayed on a computing device associated with the customer) to be output to implement the solution prediction 108 to resolve the issue prediction 107. In at least some aspects, the implementation module 106 utilizes a supervised machine-learning model, having been trained on training data 101, to generate optimal recommended actions 109 based on a particular customer's activities and actions received as active customer data 102. For example, a customer who has failed a password challenge, on a website or computer application associated with the prediction engine 100, a single time is presented a password prompt on an interface of the associated computing device for the customer; a particular customer who has failed a password challenge multiple times is directed to a ‘FAQ’ page on how to reset a password via the recommended action 109. Thus, in at least some aspects, the prediction engine 100, may further be configured to determine a context of the issue encountered by a customer when browsing online or with a native application associated with the entity (e.g. via a computing device such as the computing device 200 in FIG. 2), and thus customize the recommended action 109 according to such determined context.

As shown in FIG. 1, input data sources for the prediction engine 100 may include training data 101 (e.g. previous customer behaviours and activities performed online; previous issue(s) associated with previous customer behaviours and activities performed online; actions undertaken by previous customers online; solution success rate for the actions undertaken by previous online customers; previous customer feedback as provided online on previous predicted solution(s)) and active customer data 102.

In at least some aspects, the training data 101 may include historical customer behaviours when interacting online, customer activities previously undertaken; customer issue(s) detected online; issue solution(s) for online activity and customer feedback processed by the prediction engine 100 and associated computing device (e.g. computing device 200 in FIG. 2) in a prior time period. Such information may have been received or otherwise captured while one or more customers of an entity is navigating online such as via a computer application or via a website from one or more other computing devices in communication with the computing device 200 of FIG. 2 such as across a communication network, or directly input into the computing device 200, or a combination of the aforementioned receiving methods.

Referring to FIGS. 1 and 2, the data extraction module 103 is configured to extract key features from the input data (e.g. training data 101; active customer data 102). Such key features may be defined based on prior iterations of the prediction engine 100 as being key contributors (e.g. based on high correlation values) to accurately predict customer issue(s) and accurately predict successful solutions to customer issue(s). Such key features extracted from the input data may include but are not limited to: geo-data associated with geographical information for a customer; device profile data associated with a device through which a customer is interacting with an application from prediction engine 100 and in communication with; and other online data such as: customer activity data; customer behavioural data, customer profile data. The geo-data may include but not limited to: geographical information for where a device interaction originates from and is processed (e.g. computing device 200). The device profile data may include but not limited to: the type of computing device (e.g. computing device 200) used by the customer; device signature including IP address and version information of the device. The customer activity data may include but not limited to: the actions or activities the customer is performing while navigating online such as visiting various website or interacting with various pages of a computer application for a particular entity; the sequence of actions or activities the customer has previously performed; the order of previous webpage visits by the customer; customer feedback on previous issue predictions (e.g. issue prediction 107); and customer feedback on previous solution predictions (e.g. solution prediction 108). The customer behavioural data may include but not limited to: the time the customer is performing an online action or activity; the time of previous online actions or activities performed by the customer; the rate at which the customer performs online actions or activities; the order in which the customer performs online activities or actions. Customer profile data may include but not limited to: customer account information; and frequent customer actions.

Once key features are extracted from the input data, the associated data values and metadata for the extracted features may be input into the issue module 104. The issue module 104, having been trained on training data 101, predicts, based on data values and metadata of key features extracted from active customer data 102, issue(s) likely encountered by a particular customer. The issue module 104 may be prompted to output an issue prediction 107 based on the occurrence of a previous action (e.g. the customer contacting support; the customer visiting the ‘FAQ’ web page; the customer failing a password challenge on a login website for an entity resource). The issue prediction 107 may be output to a graphical user interface on a computer system in communication with prediction engine 100 (e.g. output the issue prediction 107 to the graphical user interface of a computer associated with the customer such as the computing device 200). The issue prediction 107 may further be input into the solution module 105. The solution module 105, having been trained on training data 101, predicts, based on data values and metadata of key features extracted from active customer data 102 and issue prediction 107, likely solutions to predicted customer issue(s) experienced while navigating online. The solution prediction module (e.g. solution module 105) may be prompted to output a solution prediction 108 based on the occurrence of a previous action (e.g. the customer contacting support via a customer support website for the entity; a request for assistance via an FAQ page; the customer visiting a particular webpage or taking a particular course of actions on a webpage). The implementation module 106, having been trained on training data 101, determines, based on data values and metadata of key features extracted from active customer data 102, the online recommended action 109 to assist with the customer's predicted issue(s).

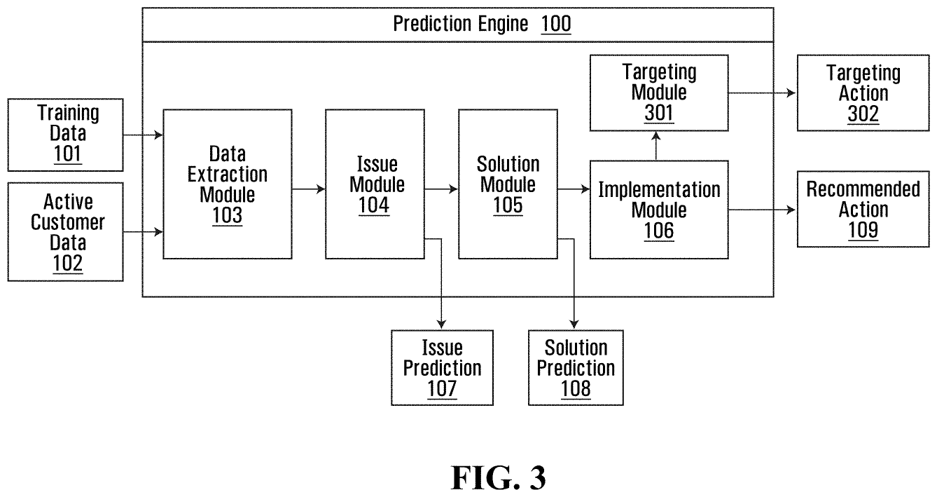

FIG. 3 illustrates an example implementation of the prediction engine 100, in accordance with one or more aspects of the present disclosure. The associated data values and metadata for the features extracted by data extraction module 103, with one or more of: the recommended action 109 determined from implementation module 106; the issue prediction 107 predicted by issue module 104; and the solution prediction 108 predicted from solution module 105; may be input into a targeting module 301 which, having been trained on training data 101, determines a targeting action 302 associated with a particular customer's behaviours and activities as performed online (e.g. via a computing device 200 and/or connected computing devices). The targeting module 301 may be prompted to output one or more customized online solutions such as the targeting action 302 (e.g. displaying credit card offerings offered by the entity to the online customer on a webpage) based on the occurrence of a previous action or behaviour (e.g. the customer searching for queries on how to obtain a credit card online; the customer visiting an ‘FAQ’ page containing information on obtaining a credit card; the customer starting an online application for a credit card while not completing such application online). Data associated with the interaction by a customer interacting online (e.g. via the computing device 200) with targeting action 302 (e.g. signing up for a credit card displayed) may further be used train or reinforce targeting module 301.

FIG. 2 illustrates example computer components of an example computing device, such as a computing device 200 for providing the prediction engine 100 described with respect to FIG. 1, in accordance with one or more aspects of the present disclosure.

The computing device 200 comprises one or more processors 201, one or more input devices 202, one or more communication units 205, one or more output devices 204 (e.g. providing one or more graphical user interfaces on a screen of the computing device 200) and a memory 203. Computing device 200 also includes one or more storage devices 207 storing one or more computer modules such as the prediction engine 100, a control module 208 for orchestrating and controlling communication between various modules and data stores of the prediction engine 100, training data 101 and active customer data 102. For example, the control module 208 may be configured to trigger when the issue module 104 and/or the solution module 105 and/or the implementation module 106 should further examine a particular sequence of online events captured for a customer of the computing device 200 while navigating online through various websites or computer application(s) which may be indicative of an online problem faced by the customer. The computing device 200 may comprise additional computing modules or data stores in various embodiments. Additional computing modules and device that may be included in various embodiments, are not shown in FIG. 2 to avoid undue complexity of the description, such as communication with one or more other computing devices, as applicable, for obtaining the training data 101 and/or the active customer data 102 including via a communication network, not shown.

Communication channels 206 may couple each of the components including processor(s) 201, input device(s) 202, communication unit(s) 205, output device(s) 204, memory 203, storage device(s) 207, and the modules stored therein for inter-component communications, whether communicatively, physically and/or operatively. In some examples, communication channels 206 may include a system bus, a network connection, an inter-process communication data structure, or any other method for communicating data.

One or more processors 201 may implement functionality and/or execute instructions within the computing device 200. For example, processor(s) 201 may be configured to receive instructions and/or data from storage device(s) 207 to execute the functionality of the modules shown in FIG. 2, among others (e.g. operating system, applications, etc.). Computing device 200 may store data/information (e.g. training data 101; active customer data 102; previous predictions (e.g. issue prediction 107); customer feedback on previous predictions) to storage device(s) 207.

One or more communication units 205 may communicate with external computing devices via one or more networks by transmitting and/or receiving network signals on the one or more networks. The communication units 205 may include various antennae and/or network interface cards, etc. for wireless and/or wired communications.

Input devices 202 and output devices 204 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 206).

The one or more storage devices 207 may store instructions and/or data for processing during operation of the computing device 200. The one or more storage devices 207 may take different forms and/or configurations, for example, as short-term memory or long-term memory. Storage device(s) 207 may be configured for short-term storage of information as volatile memory, which does not retain stored contents when power is removed. Volatile memory examples include random access memory (RAM), dynamic random access memory (DRAM), static random access memory (SRAM), etc. Storage device(s) 207, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable read-only memory (EPROM) or electrically erasable and programmable read-only memory (EEPROM).

The computing device 200 may include additional computing modules or data stores in various embodiments. Additional modules, data stores and devices that may be included in various embodiments may be not be shown in FIG. 2 to avoid undue complexity of the description. Other examples of computing device 200 may be a tablet computer, a person digital assistant (PDA), a laptop computer, a tabletop computer, a portable media player, an e-book reader, a watch, a customer device, a user device, or another type of computing device.

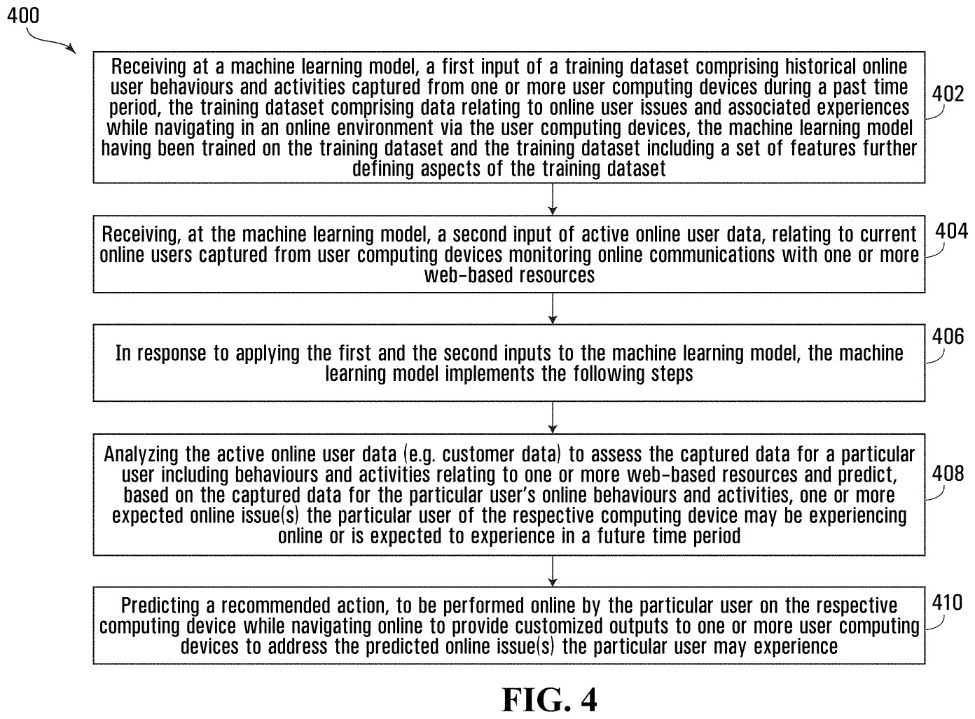

FIG. 4 illustrates a flow of exemplary operations 400 of the prediction engine 100 for automatically predicting a customer's issue(s) and intent for seeking or requiring online support such as while navigating and interacting online with one or more online resources including websites of an entity such as via the computing device 200 or another computing device, and predicting online solutions to predicted customer issue(s) as illustrated in FIGS. 1 and 2, which may be implemented by a computing device such as the computing device 200.

At operation 402, operations of the prediction engine 100 include receiving, at a machine learning model (e.g. the prediction engine 100 including a machine learning model such as in the issue module 104, solution module 105, and/or implementation module 106), a first input of a training dataset (e.g. training data 101) of previous customer behavior and activities, the training dataset including customer issues and associated customer experiences while navigating in an online environment for one or more websites, computer applications or other computing resources associated with an entity associated with the prediction engine 100, the machine learning model having been trained using the training dataset (e.g. training data 101) and the training dataset including a set of features (e.g. geo-data; device profile data, customer activity data, customer behavioural data, customer profile data, etc.) defining the training dataset.

At operation 404, the operations of the prediction engine 100 further include receiving, at the machine learning model, a second input of active customer data (e.g. active customer data 102 relating to online customer activity and transactions performed online) as shown in FIG. 1, including the activities and behaviours of active customers while navigating online such as interacting with one or more online resources of an entity associated with the prediction engine 100, defined using a same set of features as the first input. In some aspects, the data extraction module 103 may be configured to extract a similar set of features from the training data 101 and the active customer data 102, and utilize the features to extract data values and metadata from the training data 101 and the active customer data 102, for further processing by one or more machine learning model (e.g. issue module 104, solution module 105, and/or implementation module 106).

At operation 406, in response to applying the inputs to the machine learning model(s) (e.g. see also FIGS. 1-3 as examples), the machine learning model (e.g. a combination of the issue module 104 and the solution module 105) is configured at operation 408 to predict issue(s) a particular customer is experiencing while navigating in an online environment associated with a particular entity based on the contextualization of the customer's experience as indicated by the activities and behaviours of the customer and/or predict a particular customer's intent for seeking support, and predict probable solution(s) to the predicted issue(s) and/or intent for seeking support.

At operation 410, the model (e.g. provided by the implementation module 106) is configured to determine recommended actions to address the predicted issue(s) (e.g. issue prediction 107) and/or implement the predicted solution(s) (e.g. solution prediction 108), in accordance with the contextualized customer's experience. As described earlier, in at least some embodiments, the model (e.g. provided by targeting module 301 illustrated in FIG. 3), is configured to determine a targeting action (e.g. targeting action 302) associated with a particular customer's behaviours and activities which may be presented on one or more computing devices such as a user interface of a customer device (e.g. computing device 200) in real-time while navigating online.

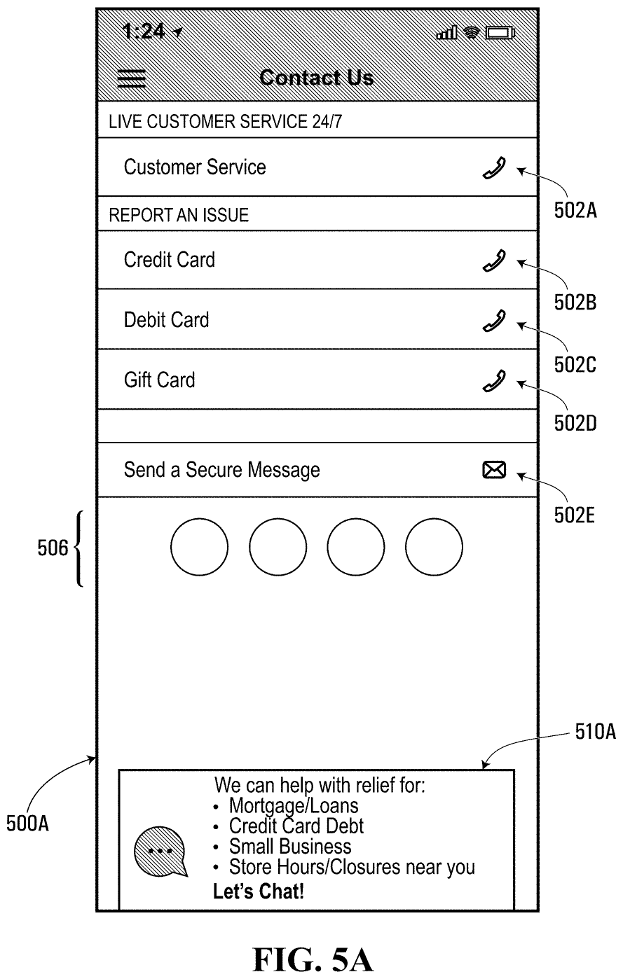

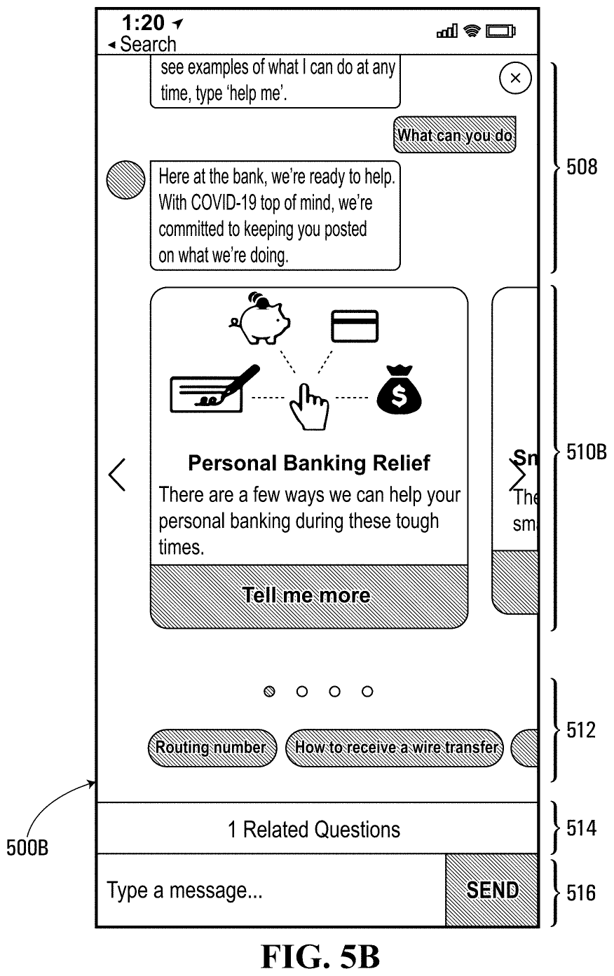

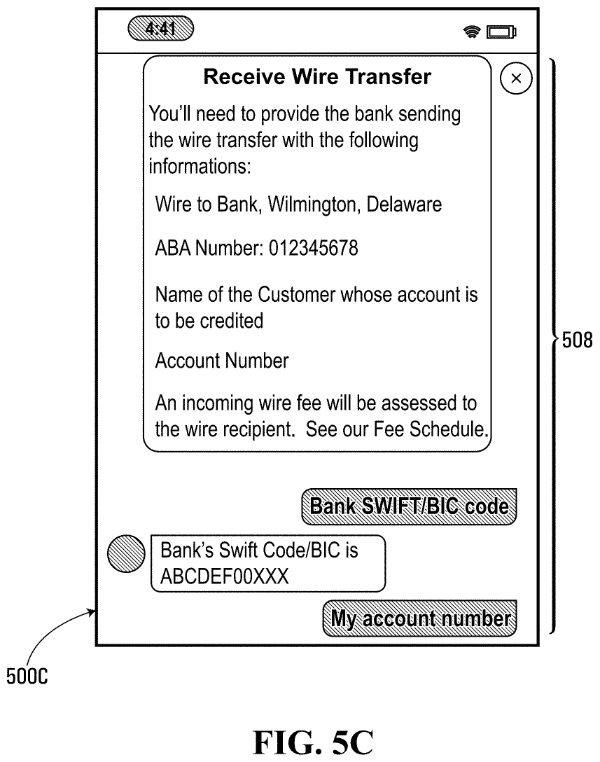

FIG. 5A-5C shows views 500A-500C of a user interface (UI) comprising a plurality of UI elements (e.g. 502-520 etc.) of a display such as for computing device 200 indicating for example, customer interactions while navigating online, either via a website or through a native application present on the computing device 200, and one or more recommended computerized solutions to predicted issues encountered online such as access to computing resources to be displayed on the user interface for subsequent interaction thereof. The UI elements may be configured to receive inputs (e.g. such as for input device(s) 202) and/or display or otherwise transmit outputs (e.g. such as for output device(s) 204).

View 500A comprises a plurality of communication controls including communication control 502A, communication control 502B, communication control 502C, communication control 502D, and communication control 502E. Communication controls are represented as distinguished UI regions or icon depictions. Communication controls may be configured to connect a customer with associated computing resources, such as support websites and/or chat bots and/or connectivity with another supporting computing device. In accordance with an example, a customer may interact with communication controls (e.g. communication control 502A, communication control 502B, communication control 502C, communication control 502D, and/or communication control 502E) to initiate a communicative interaction with a supporting resource, by way of online messaging, voice communication, video communication, or other method of communication. As previously described, in accordance with an example embodiment, the interaction of a customer with communication controls may prompt an output by one or more machine learning models (e.g. prompting the output of issue prediction 107 from issue module 104 of prediction engine 100).

View 500A comprises one or more UI regions, including region 506, 510A. A region here is a portion of a display having a respective location. The location is typically a two dimensional shape. A region may comprise a control for receiving input and invoking an action or may comprise information displayed to the user. Region 506 comprises a plurality of icons, which may receive input from the customer, for example by way of gesture or interaction. Region 506 may comprise a plurality of hyperlink buttons that direct the user to pre-determined websites, such as social media websites.

Referring to FIGS. 5A-5B, regions 510A and 510B comprise a plurality of information controls, which may output information for the customer (e.g. in accordance with recommended action 109) and/or received input from a customer by way of gesture or interaction (e.g. as an aspect of input device(s) 202). In accordance with an example, regions 510A and 510B may be configured to display online resources such as web links (e.g. targeting action 302) to a customer on the user interface based on a customer's online behaviours and actions (e.g. received as active customer data 102) such as interactions with the user interface providing computing resources for a particular entity as shown in FIGS. 5A-5C. In the present example, the customer interacting with the user interface may have recently requested a credit limit increase on a credit card product via online transactions. A machine learning model, such as targeting module 301 as an aspect of prediction engine 100 may track online behaviours and sequence of events and identify the customer as one who is likely interesting in a new credit card product. As such, targeting action 302 may direct the update or display of interactive information within regions 510A and/or 510B.

In one example, in addition to providing online support to online customers via the prediction engine 100 in a time efficient manner, a user of the computing device 200 may be targeted with certain online products and services (e.g. see region 510A) depending on that customer's behavior and activities. For example, a customer who has searched for credit card options may be targeted with certain credit cards tailored to that customer's monthly income and spending as may be predicted via the targeting module 301.

FIG. 5B shows a view 500B of the user interface, comprising a plurality of UI elements in respective regions 508, 512, 514, 516 etc. of a display such as for computing device 200. Region 512 comprises issue information data, for example a dynamically updated list of frequently asked questions. The issue information data of region 512 may be updated or otherwise modified based on predicted issue(s) experienced by a customer (e.g. issue prediction 107), predicted customer intent for seeking support, and/or predicted solution(s) to predicted customer issue(s) (e.g. solution prediction 108). The issue information data comprised in region 512 may be configured to received input from the customer, for example by way of gesture or interaction, and direct the customer to electronic resources containing further information. In accordance with an example, region 512 may contain a dynamically updated list of frequently asked questions, which have been selected and customized as likely relevant to a particular customer based on issue prediction 107. In the present example, the issue information data within region 512 may be interacted with by the customer, to direct the customer to electronic resources including web pages containing further information on the question. Interaction with issue information data within region 512 may direct the customer to a further UI view of a display such as for computing device 200, which may display information on predicted solution(s) to the frequently asked question the customer interacts with within region 512.

Region 514 may comprise related issue information data, for example a display of a likely set of related questions to predicted customer issue(s) so that the customer of the user interface may easily select one of the possible options for further guidance while navigating online and with the user interface of FIG. 5B (e.g. issue prediction 107).

Region 516 comprises an input screen portion (e.g. as may be displayed by the computing device 200) for providing a mechanism which the customer may interact with one or more other computing devices for providing resources for the entity (e.g. as an aspect of input device(s) 202). By way of example, region 516 may provide a text box in which the customer may input queries and/or communicate with a chat bot.

As illustrated in FIGS. 5B-5C, region 508 in views 500B and 500C comprises communication information data, such as prior communication messages of a customer (e.g. as received on a user interface of the computing device 200 providing the view 500B or 500C), and information transmitted to the display for the customer, such as by a chat bot or by a machine learning model (e.g. prediction engine 100). Region(s) 508 shown in example views 500B, and 500C may provide information to the customer related to predicted online issue(s) experienced by the customer experienced while navigating in the online environment for the entity associated with the user interface of the view 500B, the predicted intent of the customer for seeking support, and/or the predicted solution(s) to the customer's predicted issue(s). By way of example, region 508 may display information related to the predicted online solution(s) to a customer's predicted online issue(s), and provide an explanation online for the customer on how to implement such a solution. By way of further example, region 508 may display a communication history between a source device and a destination device such as a customer service agent and the customer, the customer service agent having been informed of the customer's predicted issue (e.g. as output by issue module 104 as part of prediction engine 100).

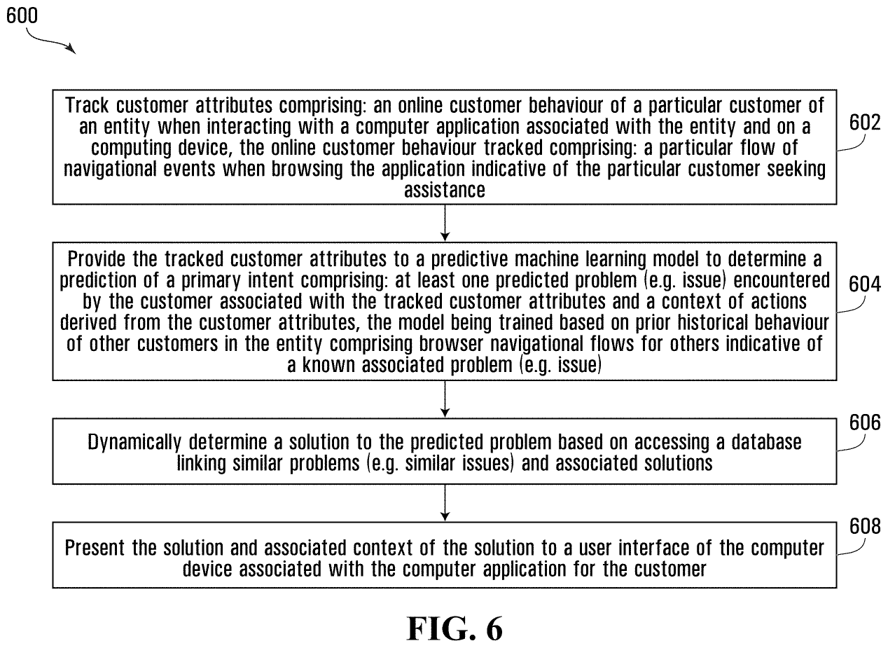

Referring to FIG. 6, shown is an example flow chart of operations for the computing device 200 and the associated prediction engine 100 (e.g. as depicted in FIGS. 1-3), in accordance with an embodiment.

Generally, in at least some aspects, the prediction engine 100 provides a context aware machine learning model for generating online context aware solutions to predicted online issues encountered by a user of a computing device (e.g. computing device 200) on an associated user interface output (e.g. see FIGS. 5A-5C). Such online solutions may include, as shown in FIGS. 5A-5C, a dynamically generated frequently asked questions, or custom chat bot conversation generated on a user interface of the computing device 200 (e.g. see FIGS. 5B and 5C0. In at least some aspects, the prediction engine 100, comprises one or more context-aware machine learning implementations and analyzes individual customer's online behavior and activities (e.g. as captured via the computing device 200) in order to contextualize a customer's online experience and proactively predicts a primary intent of why the customer may be in need of online assistance/support/resources and provides customized responses that address the primary intent and context experienced by the customer while interacting online such as via the user interface of the entity associated with the online resource shown in FIGS. 5A-5C.

In at least some aspects, the prediction engine 100 operates using one or more machine learning models (e.g. an issue module 104, a solutions module 105, and an implementations module 106), trained on an input training dataset (e.g. training data 101) of online customer behavior and activities associated with various problems/experiences. The trained model(s) may then predict what issue(s) a customer navigating online may be experiencing based on the summation of data associated with that customer, of which data including both the history and the sequence of certain events may be considered in predicting the customer's intent.

Referring again to FIG. 6, shown is a set of operations 600 for dynamically providing predictive context-aware solutions on computing devices to online customers (e.g. via computing device 200 such as via user interfaces shown in FIGS. 5A-5C).

First operation step 602 includes tracking customer attributes such as online customer behaviour of a particular customer of an entity when interacting with a computer application (e.g. the computer application having views shown in FIGS. 5A-5C) associated with the entity and on a computer device (e.g. the computing device 200). Notably, the online customer behaviour tracked including tracking a particular flow of navigational events when browsing the application indicative of the particular customer seeking assistance.

For example, a user of the computing device 200 who has unsuccessfully attempted to log in to their online account (e.g. for an application associated with user interface views as shown in FIGS. 5A-5C) and then clicks on the “forgot password” option may be tracked and identified as a customer who is experiencing issues with accessing their account and needs assistance resetting their password. By way of another example, a user of the computing device 200, who has performed a certain flow of navigational transactional events, such as having successfully completed their first mobile deposit may be identified as a customer with certain potential online issues requiring online solutions to inquiries such as to recommended next steps after cheque has been deposited using mobile deposit.

At a second operation step 604, the computing device 200 and/or the prediction engine 100 is configured for providing the tracked customer attributes to a predictive machine learning model (e.g. an issue module 104) to determine a prediction of a primary intent comprising: at least one predicted problem encountered by the customer associated with the tracked customer attributes and a context of actions derived from the customer attributes. Such context may include additional information about the online user interactions captured via the computing device 200, including device identification data for the computing device 200, location of the computing device 200 during the navigational events, time frame of the navigational events, length of each interaction in the navigational events, and particular sequence of interactions in the navigational events with at least one of a website and the customer application leading to a request for assistance. Other context examples may include, as described above, historical customer behaviour such as an indication that a similar prior navigational flow of events occurred for the same user or other similar users of interest as determined by the prediction engine 100. Additionally, in at least some embodiments, the machine learning model(s) of the prediction engine 100 are trained based on prior historical behaviour of other customers in the entity comprising browser navigational flows for others indicative of a known associated problem.

At a third operation step 606, the computing device 200 and/or the prediction engine 100 is configured to dynamically determine a solution (e.g. via a solution module 105) to the predicted problem based on accessing a database linking similar problems and associated solutions.

In one example implementation, the prediction engine 100 helps determine (e.g. via the issue module 104) what specific online steps a customer may still need to perform in order to successfully complete a particular transaction, by using prior datasets (e.g. for the training data 101) that contextualizes successful transactions. For example, the machine learning model of the issue module 104 may recognize that in order to successfully complete an e-transfer of funds, most customers who meet a set of defined criteria (e.g. customer attributes): A, B and C have completed the e-transfer by performing a known series of steps, X and Y (e.g. as per training data 101). As such, for an online customer tracked by the prediction engine 100, who meets criteria A, B and C (e.g. active customer data 102) and whose intent is predicted to be the completion of an e-transfer (e.g. via issue module 104), the prediction engine 100 may suggest performing a series of online steps: X and Y, as determined via the implementation module 106 and/or solution module 105.

Referring again to second operation step 604, in one example, the issue or problem predicted by the prediction engine 100 (e.g. issue module 104) may also be contextualized. For example, when a user of a user interface for the entity (e.g. via the computing device 200 such as on views shown in FIGS. 5A-5C) clicks on the “Contact Us” web page or a different tagged web page such as the “FAQs”, the customer can be targeted, in one example embodiment, via the targeting module 301, with a customized online prompt that summarizes the customer's experience followed by a request to confirm that their intent for seeking support is accurate as the prediction engine 100 predicted. Conveniently, in the example provided, and in at least some embodiments, the process of manually seeking support can be short-circuited by bypassing the need for customers to contextualize their experience themselves or search through contents that may or may not match the context of what they are experiencing. In at least some aspects, by providing online content deemed most relevant to the customer based on that customer's predicted issue based on online interactions, the prediction engine 100, can in at least some aspects, help improve the overall online experience including interactions with a user interface of the computing device 200.

In other aspects, the prediction engine 100 may be configured to relay the predicted issue to other related computing devices such as chat bots in communication with the computing device 200, so that the prediction engine 100 can automatically provide a summary reference of what the customer has experienced while navigating online, the predicted likely intent for the customer's navigational issue(s), and likely solutions to the issue(s) that the customer is predicted to be experiencing. In at least some aspects, there is minimization of the time required to contextualize the issue to other resources.

Referring again to FIG. 6 and the prediction engine 100 of FIGS. 1-3, the prediction engine can, in at least some aspects, be continuously trained and further improved to better predict online customer issue(s) based on a feedback system and new customer activities. In particular, after each online transaction where the prediction engine 100 was used, the customer may be prompted to provide feedback on the user interface as to whether the model was found to be helpful. Transactions that were found to be helpful would help reinforce the existing machine learning models in the prediction engine 100. To the extent the machine learning model(s) was found to be unhelpful for a particular context, the specific online transaction may be further analyzed including the steps ultimately taken by the customer on the associated user interface (e.g. see FIGS. 5A-5C) to resolve the online issue(s) in order to potentially identify new issue(s) or entry points for existing issue(s) such as to retrain the machine learning models of the prediction engine 100.

Referring again to FIG. 6, fourth operation step 608 includes presenting the online solution and associated context of the solution to a user interface of the computing device 200 associated with the computer application for the customer, examples of which have been described with reference to views shown in FIGS. 5A-5C.

One or more currently preferred embodiments have been described by way of example. It will be apparent to persons skilled in the art that a number of variations and modifications can be made without departing from the scope of the disclosure as defined in the claims.

What is claimed is:

1. A computer system for dynamically providing predictive context aware solutions on computing devices to online customers, the computer system comprising:
a processor configured to execute instructions;
a non-transient computer-readable medium comprising instructions that when executed by the processor cause the processor to:
track customer attributes comprising: an online customer behaviour of a particular customer of an entity when interacting with a computer application associated with the entity and on a computer device, the online customer behaviour tracked comprising: a particular flow of navigational events when browsing the application indicative of the particular customer seeking assistance;
provide the tracked customer attributes to a predictive machine learning model to determine a prediction of a primary intent comprising: at least one predicted problem encountered by the customer associated with the tracked customer attributes and a context of actions derived from the customer attributes, the model trained based on prior historical behaviour of other customers in the entity comprising browser navigational flows for others indicative of a known associated problem; and
dynamically determine a solution to the predicted problem based on accessing a database linking similar problems and associated solutions.

2. The system of claim 1, wherein the instructions further cause the processor to present the solution and associated context of the solution to a user interface of the computer device associated with the computer application for the customer.

3. The system of claim 2 wherein tracking the customer attributes of the online customer behaviour further comprises the instructions configuring the processor to track flow of user events on the computer application including browsing to navigate to one of:
select online assistance using the application;
browse to an informational web page for reviewing frequently asked questions;
browse to a support web page for obtaining assistance; and
initiate a chat session to request assistance from a support resource.

4. The system of claim 2, wherein the instructions further configure the processor to:
track feedback from the computer device comprising:
determine whether a positive response accepting the solution or a negative response declining the solution was received on the user interface of the computer device; and
send back the positive or the negative response to the predictive machine learning model to revise the training of the model based on the feedback.

5. The system of claim 2, wherein the customer attributes are selected from the group comprising:
customer interaction behaviour online, customer interactions with the computer application, location of the computer device during the navigational events, time frame of the navigational events, length of each interaction in the navigational events, and particular sequence of interactions in the navigational events with at least one of a website and the customer application leading to a request for assistance.

6. The system of claim 5, wherein the customer attributes further define the context of actions, and the context of actions is further used to refine the predicted intent based on other users having a similar context of actions and the navigational events to the particular customer.

7. The system of claim 2, wherein the model utilizes the particular flow of navigational events for the customer leading to the request for assistance online on the computer application for prediction of intent based on determining a similarity of the particular flow of navigational events to prior similar customer navigational events leading to a defined request for assistance for other customers interacting with the application.

8. The system of claim 7, wherein the model further utilizes the particular flow of navigational events to retrieve associated known problems encountered by the other customers to automatically predict the one or more problems likely encountered by the customer.

9. The system of claim 8, wherein the instructions further configure the processor to:
utilize the tracked customer attributes, via the predictive machine learning model, comprising the particular flow of navigational events to initially predict an expected transaction to be performed at a future time subsequent to the navigational events based on a current sequence of interactive events; and
triggering a prediction by the predictive machine learning model of the intent and the at least one problem in response to determining that the expected transaction has not occurred at the future time, the predicting problem and the solution additionally based on the expected transaction.

10. A computer implemented method for dynamically providing predictive context-aware solutions on computing devices to online customers, the method comprising:
tracking customer attributes comprising: an online customer behaviour of a particular customer of an entity when interacting with a computer application associated with the entity and on a computer device, the online customer behaviour tracked comprising: a particular flow of navigational events when browsing the application indicative of the particular customer seeking assistance;
providing the tracked customer attributes to a predictive machine learning model to determine a prediction of a primary intent comprising: at least one predicted problem encountered by the customer associated with the tracked customer attributes and a context of actions derived from the customer attributes, the model being trained based on prior historical behaviour of other customers in the entity comprising browser navigational flows for others indicative of a known associated problem; and
dynamically determining a solution to the predicted problem based on accessing a database linking similar problems and associated solutions.

11. The method of claim 10, further comprising: presenting the solution and associated context of the solution to a user interface of the computer device associated with the computer application for the customer.

12. The method of claim 11 wherein tracking the customer attributes of the online customer behaviour further comprises tracking flow of user events on the computer application including browsing to navigate to one of:
select online assistance using the application;
browsing to an informational web page for reviewing frequently asked questions;
browse to a support web page for obtaining assistance; and
initiate a chat session to request assistance from a support resource.

13. The method of claim 11, further comprising:
tracking feedback from the computer device comprising:
determining whether a positive response accepting the solution or a negative response declining the solution was received on the user interface of the computer device; and
sending back the positive or the negative response to the predictive machine learning model to revise the training of the model based on the feedback.

14. The method of claim 11, wherein the customer attributes are selected from the group comprising:
customer interaction behaviour online, customer interactions with the computer application, location of the computer device during the navigational events, time frame of the navigational events, length of each interaction in the navigational events, and particular sequence of interactions in the navigational events with at least one of a website and the customer application leading to a request for assistance.

15. The method of claim 14, wherein the customer attributes further define the context of actions, and the context of actions is further used to refine the predicted intent based on other users having a similar context of actions and the navigational events to the particular customer.

16. The method of claim 11, wherein the model utilizes the particular flow of navigational events for the customer leading to the request for assistance online on the computer application for prediction of intent based on determining a similarity of the particular flow of navigational events to prior similar customer navigational events leading to a defined request for assistance for other customers interacting with the application.

17. The method of claim 16, wherein the model further utilizes the particular flow of navigational events to retrieve associated known problems encountered by the other customers to automatically predict the one or more problems likely encountered by the customer.

18. The method of claim 17, further comprising: the predictive machine learning model configured to utilize the tracked customer attributes comprising the particular flow of navigational events to initially predict an expected transaction to be performed at a future time subsequent to the navigational events based on a current sequence of interactive events; and triggering a prediction by the machine learning model of the intent and the at least one problem in response to determining that the expected transaction has not occurred at the future time, the predicting problem and the solution additionally based on the expected transaction.

19. A non-transitory computer-readable medium containing computer program code that are executable by a processor for providing predictive context-aware solutions on computing devices to online customers, the processor to perform steps of:
tracking customer attributes comprising: an online customer behaviour of a particular customer of an entity when interacting with a computer application associated with the entity and on a computer device, the online customer behaviour tracked comprising: a particular flow of navigational events when browsing the application indicative of the particular customer seeking assistance;
providing the tracked customer attributes to a predictive machine learning model to determine a prediction of a primary intent comprising: at least one predicted problem encountered by the customer associated with the tracked customer attributes and a context of actions derived from the customer attributes, the model being trained based on prior historical behaviour of other customers in the entity comprising browser navigational flows for others indicative of a known associated problem; and
dynamically determining a solution to the predicted problem based on accessing a database linking similar problems and associated solutions.
